(19) United States
(12) Patent Application Publication
(10) Pub. No.: US 2025/0239586 A1
(43) Pub. Date: Jul. 24, 2025

(54) Apparatus And Method For Inductive Heating Of Coated Web Substrates During Process Operations

(71) Applicant: Durr Systems, Inc., Southfield, MI (US)

(72) Inventors: Paul G. Seidl, DePere, WI (US); Steven Zagar, Luxemburg, WI (US)

(21) Appl. No.: 18/415,868

(22) Filed: Jan. 18, 2024

(51) Int. Cl. H01M 4/04; F26B 3/34; F26B 3/347

(52) U.S. Cl. CPC H01M 4/0471; F26B 3/343; F26B 3/347; H01M 4/0404

(57) ABSTRACT

Apparatus, system and method for simultaneously drying a coating on a substrate using at least two different drying phenomena, for example, inductive heating and convective heating, or inductive heating and a combination of convective heating and infrared heating. A coating on a substrate is dried by generating heat in the substrate while simultaneously applying convective heat and/or radiant heat to the coating. Simultaneous drying refers to drying of the same region of a substrate at the same time, and in a particular embodiment, subjecting the same region of a substrate to inductive heating and convection at the same time. Preferably the substrate is at least partially conductive.

### BACKGROUND

Rolls of substrate material are often coated with a liquid-suspended mixture such as an ink, adhesive resin, varnish, or other material forming a wet film to be dried. In special cases, the material to be applied to the substrate surface may be a mixture of dry compounds with binder such as in powder form. In its finished form the dried film adhering to the substrate comprises a web-based product having useful applicability according to the properties of the material constituents. In some cases, the substrate material may be paper or board stock which is printed with ink to produce books, magazines or packaging materials. In other cases, the substrate may be polymer film such as polyethylene, polyethylene terephthalate, polyimide and the like and coated with a wet adhesive film or another polymer dissolved in a liquid solvent to form a second functional layer on the first layer being said polymer substrate. In certain cases, the substrate web may comprise a metal foil (foil web), a metallized or otherwise conductively prepared, finished or coated web, such as aluminum or copper as in the production of battery electrodes, also referred to as current collectors. In the manufacture of electrodes for lithium-ion battery cells, the coating material applied to the substrate is typically a liquid-suspended slurry or paste typically composed of fine powders mixed with a binder material, typically a polymer, which may be water-soluble. In other cases, the binder is dissolved in an organic solvent such as NMP, NEP (1-Ethyl-2-pyrrolidon), TEP, EAA (Ethylacetoacetate), DMAC, GBL (gamma-Butyrolacton), xylene, acetone, alcohol or similar industrial solvent selected to dissolve said organic binder to form a coatable liquid. As a special subset application, the coating material may be comprised of dry, fine powders mixed with a binder with no aqueous or liquid solvent suspension.

For the purposes of this description, the term solvent may apply to water in aqueous coatings wherein the solvent is water, or the term solvent may apply to coatings having one or more organic solvents as mentioned previously, or a blend of water and one or more organic solvents. In the dry-coating application, there will be little-to-no solvent supporting the dry powder, nor an aqueous suspension. In all cases save for the dry-powder format, the term solvent refers to the vehicle dissolving a binder or binder-like material introduced to render the coating in a fluid form allowing said coating to be applied as a type of liquid to a substrate in a coater apparatus. The dry powder application requires special trade treatment to effect coating adherence to electrode backing surfaces.

In the manufacture of battery electrodes, a roll of metal/metallized/conductively prepared web/foil in strip form is unwound and conveyed through a coating line and coated in a continuous or semi-continuous fashion either in lanes or full width across the width direction of the foil web. The coating may be applied on one or both sides of the web. FIG. 1a illustrates a single-sided coating example. FIG. 1b illustrates a simultaneous double-sided coating example. In full-width continuous coating, the edges of the foil web are most often not coated, leaving bare (conductive) web exposed at said edges. The coating on each side may be applied by a suitable coating apparatus, preferably a slot die, 12, (nozzle). Alternative coating devices include roll applicators, comma coaters or gravure cylinders, depending on required coating thickness and rheological properties of the wet slurry. In Dry-Coating Processes, the dry powder may be applied via electrostatic, deposition or mechanical methods. The dry-coating process for electrode manufacturing may also comprise of a basic two-step process: in at least one first production step a dry free-standing or self-supporting film of active material is produced for example by means of a roller press or extrusion of a powder mixture comprising active material and an activated binder; whereas in a seconding production step the pre-manufactured film is laminated onto a current collector web. In certain cases, the coating is applied in discontinuous patches along the length of travel direction of the foil web typically using a slot die coater leaving bare current collector exposed between said patches. Lanes may also be coated leaving bare current collector exposed between said lanes. These bare regions provide uncoated foil areas for connection tabs to be connected between individual electrodes in the assembly of battery cells as batteries, see FIG. x.

In certain cases, the aforementioned web-based products are coated on one face (side) of the substrate in a roll-to-roll process, as depicted in FIG. 1a (where 10 depicts a web, 12 a slot die coater, 11, 13 and 14 rollers, and 15 a dryer). In these cases, a wet coating is applied on a moving web and dried in an oven to remove solvent thereby solidifying the applied coating. In certain cases, the aforementioned web-based products are coated on both faces (sides) of the substrate. In typical cases wherein both faces of the substrate are to be coated, a first wet coating is applied on a moving web substrate and dried in an oven followed by application of a second wet coating which is subsequently dried in a second dryer. In a preferred embodiment for production of battery electrodes the wet slurry is applied to both sides of the foil web and subsequently dried in an oven. This arrangement is referred to as simultaneous dual-side coating and drying and is depicted in FIG. 1b (where like numerals refer to like features of other figures, and where element 16 is a roller). In the case of lithium-ion electrode manufacture this arrangement is particularly advantageous in enhancing productivity needing only one drying step following application of the wet coating slurry to both sides.

A first drying step removes nearly all the solvent from wet coating applied to foil webs to produce battery electrode material, referred to as primary drying. A second drying step is typically included to reduce the residual solvent and especially aqueous moisture content to very low levels prior to the cell assembly step. In this secondary drying step, the residual solvent entering the dryer is already low, typically less than 1% by weight in the coating layer but is to be further reduced to less than 400 ppm and in some cases lower than 100 ppm to meet required specifications for cell assembly.

It is known to those skilled in the art of coating and drying that certain coatings exhibit defects from drying if the applied heat and mass transfer are too aggressive or otherwise disturb the quality of the wet substrate as it dries. Such defects include loss of adhesion to the substrate, blisters, surface roughness resembling an orange peel, mottled appearance, crazed surface or cracks through the dried coating thickness. In the drying of lithium-ion electrodes, the development of so-called “mud cracks” and/or loss of adhesion can be particularly problematic in prior art drying, especially with thicker/heavier coating weights. As applied, a coating slurry may contain typically 30 to 80% solvent by weight. As the wet surface of the coating dries and begins to solidify, the volume of the coating at the surface also shrinks in volume owing to the removal of solvent by evaporation. In some cases, especially with thicker coatings of 50 microns or more, the coating slurry near the interface of the foil substrate undergoes a lesser magnitude of solvent removal as drying progresses compared to the free surface exposed to convection air. Consequently, a portion of the coating thickness near the free surface of the coating undergoes a volumetric strain owing to volumetric shrinkage, which may lead to stress cracks in the dry or nearly dry coating material most notably at the exposed surface. These cracks result in unacceptable electrode material for battery cell manufacture. In order to avoid these defects, in most cases the line speed of the coating process must be reduced to allow gentle drying rates while removing water or solvent from the coating and reach acceptable residual solvent levels, which are typically lower than 1% and, in many cases, desired to be less than 0.1% of the coating mass.

During drying, the coated areas are heated and the wet coating along with the foil substrate present a thermal heat load in terms of sensible heating of the coating and web substrate, and in the latent heat of vaporization of the solvent(s). In contrast, the aforementioned areas of bare substrate do not have wet coating and therefore do not exhibit the thermal heat load of drying as the coated areas undergo. Consequently, these bare substrate areas typically reach higher temperatures than the adjacent coated areas during the progression of drying. In the case of convection drying, the bare substrate quickly reaches the temperature of the convection air in contact with the substrate. On the other hand, the coated areas increase in temperature more slowly and tend to remain at a depressed temperature from that of the convection air owing to the greater sensible heat load of the wet coating and the wet bulb depression (evaporative cooling) effect in drying. This develops a local temperature gradient in the substrate between the coated and bare regions, causing differential thermal growth of the substrate between these two areas, as represented in FIG. 2b. The resulting thermal strain may buckle the substrate if the temperature differential becomes too large, rendering the product electrode unusable. In order to avoid excessive thermal strain and buckling, the applied convection heat transfer coefficient and air temperature are often limited, thus limiting the production throughput in order to maintain acceptable product quality. Further, if drying energy is applied to the substrate by non-convective means such as infrared emitters or dielectric field, the temperature of the bare substrate may be further increased while providing drying heat to the coated areas of the substrate. For example, (Nissan) Kazama et. al. U.S. Pat. No. 9,310,130 discloses a process for heating electrode material by means of induction fields. In order to avoid overheating of the bare substrate areas, they recite a means of interrupting the induction field when uncoated regions passed through the induction field. However, this method is not compatible with the current line speed capability of battery electrode coating operations. High speed interruption and restoration of the induction field is notably difficult, especially under the practical constraints of interruption time and distance within a commercial drying apparatus.

In conventional drying ovens for web-based products, the application of heat and mass transfer to promote drying is carried out with convection air at elevated temperature and, in certain cases, controlled humidity and/or solvent concentration. In convection drying ovens air is heated to a desired temperature and blown from nozzles as impinging jets to contact the web creating heat and mass transfer conditions of a controlled magnitude according to selection of air velocity, temperature and nozzle array/configuration. In order to apply gentle drying conditions, the magnitude of the heat and mass transfer is reduced by decreasing air velocity, air temperature, reduction of the size or number of air jets emanating from the array of nozzles, or some combination thereof as applied in the drying oven. This gentle drying reduces the rate of solvent removal requiring a greater amount of time to reach the end point target moisture. Considering an oven of fixed length or constrained by practical limits for oven length available for a given installation, the production line speed of the coating operation must therefore be reduced accordingly.

In certain cases additional heat flux may be applied to the wet coating by placing infrared emitters adjacent to the substrate web on one or both sides. Said infrared emitters may be situated between the air jets issuing from convection nozzles. In this manner heat flux to the substrate web may be increased by increasing the temperature of the emitters while the convection provided by the air jets is maintained or in some cases reduced to avoid disturbance of the wet coating. In some cases, especially with thicker wet film thicknesses, the combination of infrared radiation flux and convection heating reduces the tendency to form mud cracks by tending to heat the wet coating slurry layer to a higher temperature while limiting the rate of drying-out of the coating free surface from convection. By balancing the magnitude of convection heat and mass transfer with the heat flux from the infrared emitters, experiments have shown that overall solvent removal rate can be increased over that applied by convection alone while avoiding mud cracking.

Still, the addition of infrared heat flux to the drying apparatus as described previously is limited to the application of heat mainly to the exposed surface of the coating. Heat must travel from the coating surface into the material creating both thermal as well as solvent concentration gradients. In some cases, the added heat flux from the infrared emitters dissipates relatively quickly through the thickness of the wet coating by thermal conduction in the coating material resulting in negligible thermal gradients. This is especially true when the coating surface is still high in solvent fraction and low in solids content or when the applied IR heat flux is moderate in magnitude (<3000 watts/m² of web surface). Still, even this limited energy flux from the IR source must heat the surface first and conduct inward.

With applied heat flux from heated convection air, infrared heat flux, or some combination thereof, the coating is heated from the outside inward. Before significant drying has occurred, the thermal conductivity of the slurry coating is relatively high approaching that of the thermal conductivity of the liquid solvent itself. Later, as the surface dries the thermal conductivity of the partially dried coating is reduced. The drier the coating gets, the less thermally conductive it becomes, as the outer dried layers isolate inner, more wet layers from heat and mass-transfer with respect to moisture. As the local solids content in the coating surface increases further by drying, the resulting reduction in thermal conductivity results in an elevation of the coating surface temperature relative to the average bulk temperature in the coating and the temperature of the substrate. A decreasing temperature profile through the thickness of the coating from surface to the coating interface with the substrate develops. Given sufficient time under a steady application of heated convection air and/or infrared flux the coating and substrate will eventually reach a more uniform temperature matching that of the surface with the substrate also approaching this temperature. However, if the coating thickness is relatively large, the coating layer may be substantially dried out before the substrate temperature has reached that of the coating surface. If this occurs, the increase in temperature of the substrate results in thermal expansion of the substrate after the coating has solidified. Consequently, the growth of the substrate puts a strain on the dried coating tending to cause the coating to stretch in the plane parallel to the interface of coating and substrate. Several defects can occur from this developed strain. Firstly, the dried coating may crack as it is stretched by the substrate which is adhesively coupled to the coating. Secondly, the adhesion between the substrate and the coating may fail causing the coating to flake off or peel from the substrate. Thirdly, combinations of cracking, buckling and loss of adhesion may develop as progression of drying and accompanying volume reduction of the coating takes place while simultaneous thermal expansion of the substrate occurs. The resulting defect patterns in the dried electrode make it unusable as electrode material. These defects include crazing, (incipient cracks), local coating thickness variations, cracking extending through from coating surface to the substrate interface (substrate visible), separation of dried coating from the substrate in flakes or line patterns, and deformation of the substrate planarity giving rise to wrinkle patterns in the substrate. Of these various defects, so-called mud cracking is typically most pernicious the greater the applied coating thickness required. Various methods have been applied to mitigate this problem, often incurring other undesirable effects.

It has long been known that metal objects, especially objects made of iron and its alloys, can be heated by exposure to an oscillating electromagnetic field in a method known as induction heating. The practice of inductively heating non-ferrous metals may be utilized in certain cases even though the inductive coupling is not as effective as in the case of ferrous metals.

Common practice of induction heating includes heating of metal castings to relieve or induce stress, and zone refining of material billets to obtain desired metallurgical properties. In these applications the metals are brought to temperatures sufficient to alter the metallic phase structure (e.g., crystalline or amorphous metallic structure) of at least a portion of said material. In some cases, objects are heated by induction to expand a metallic object such as heating of a hub to expand and fit tightly on a shaft following subsequent cooling to lower temperatures. In most cases the objective is to heat a work piece to a high temperature while minimizing thermal losses due to radiation and convection. Therefore, most inductive treatment apparatuses are constructed and operated in a manner to maximize the temperature of the work piece. This is typically carried out by including thermal radiation shielding and insulation along with eliminating convective cooling effects.

As previously mentioned, the heating of metals in thin strip form has been explored albeit with limited commercial application in the processing of battery electrodes. Kazama et. al. U.S. Pat. No. 9,310,130 teaches a method of heating the wet coated electrode foil first with induction followed in sequence by an optional convection dryer. The foil and coating are heated to a sufficient temperature to increase the vapor pressure of the solvent such that the subsequent convection zone will then flash off the solvent. Gaugler et. al. EP 3439079A1 teaches an arrangement for an induction coil element to heat the coated web and vaporize solvent and subsequently condensing the solvent vapors on the coil element. In both these prior art examples essentially all the heat supplied for the drying thermal load is imparted by the induction fields.

In these prior art embodiments, the temperature of the bare substrate areas reaches excessive temperatures compared to the coated areas resulting in thermal distortion and buckling. Accordingly, Kazama further recites a method to interrupt the inductive field when bare foil areas pass through the field coils in an attempt to mitigate excess temperature. Such uncoated areas are necessary in the manufacture of current collectors to provide conductive tabs at the edges of the electrode cell elements as needed in assembly of cylindrically rolled or flat prismatic and pouch type batteries. The uncoated areas or “mass free zones” may be present in the form of uncoated lanes at the edges of a single width of continuous coating applied within the substrate width, and in certain cases between lanes when two or more lanes are applied within the substrate width. In some battery formats, cell tabs are configured at cell assembly requiring uncoated areas between coated patches of active electrode material along the travel direction of the current collector foil substrate. Such electrode production is often referred to as intermittent, patch or skip coating. As mentioned, Kazama teaches a method to avoid overheating of these regularly spaced mass free zones when inductively heating by actively controlling and interrupting the inductive field to diminish the energy absorbed in the intermittent uncoated areas as the web travels through the respective field elements. In this arrangement, the inductive field elements must be sized and positioned to precisely match the spacing and patch dimensions required for specific battery cell to be produced. In many cases a given electrode production line must supply a plurality of current collector formats with varied spacing dimensions between coated patches requiring a changeover of hardware to accommodate the dimensions for each production run. Further, this method does not offer a solution to the problem of overheating the uncoated areas between lanes in continuous lane coating and at the substrate web edges described above.

All of the prior art methods are essentially subject to certain limitations resulting in the need to reduce the solvent drying rate, the bare foil substrate temperature, or both, in the drying process. The impact of these limitations is in all cases a decrease of process line speed and reduced up time between changeovers resulting in lower production throughput rates, or an increase in investment cost for increased dryer length. This is a common dilemma in current practice.

With the stated problem being the issues created via the external heating of thickly coated metal foil substrates, namely, cracking/fissures and surface defects, foil substrate buckling, and the prior art solution(s) unable to solve the problem without undesirable results including slower production speeds and/or longer dryers, a desirable solution would be to generate heat internally within the coated substrate thickness, whilst applying balanced drying heat and mass transfer conditions at the surface of the coating.

### SUMMARY

The present solution relates to coated substrates, as is the common construction of the current collectors for Lithium-ion Battery electrodes, for example. Thus, it would be advantageous to add thermal energy with inductive coupling to the base substrate in combination with convective heating to incrementally raise the temperature of the substrate, and thereby promote heat flow to the coating by thermal conduction at the interface with the coating layer. Induction heating then provides an independent but additive heat contribution to the substrate combined with said convection. This heating combination is carried out concurrently, that is in the same web area of the coated substrate at the surface of the coating and within the base substrate location in interfacial contact with the coating at the same time. In some cases, infrared may also be added.

Throughout this disclosure the terms foil, metal foil, at least partially conductive substrate, web, current collector, web substrate or the like or various combinations thereof are used as synonyms and all refer to a sheet-, foil-or web-like current collector material used for example in the production of electrodes for batteries, secondary batteries, capacitators, fuel cells, or the like.

It is an object of embodiments disclosed herein to disclose such a means of raising said substrate temperature by inductive field and promote the mass transport of solvent content within the coating thickness to the free surface thereby enhancing the drying rate. A coating applied to a web substrate surface may be thought of in terms of a plurality of layers subdivided within the total coating thickness to represent the profiles of temperature and solvent content relative to position in the thickness direction. Such layers are often defined in finite element numerical models to provide a format for solution equations and calculation algorithms to predict and visualize key physical parameters such as temperature and solvent concentrations as a function of position within the coating thickness. For illustrative purposes, one could describe three such layers as: a first layer nearest to and in contact with the substrate foil, a second layer midway between the foil interface and the exposed free surface of the coating, and a third layer nearest and exposed to the free surface to the air (or other gas) within the drying environment. By supplying heating energy to the metal foil substrate directly by inductive field, the foil conductively heats said first layer at the foil interface. This imparts some level of internal heating of the coating at the substrate interface and enhances the mass transport of the liquid carrier solvent(s) within the coating toward the free surface (air interface) of the coating. Specifically, heating the coating layer in intimate contact with the substrate (e.g., metal foil) to promote mobilization of the liquid solvent from this internal position within the coating layer creates an enhanced mass transport scenario whereby the liquid solvent undergoes mass transfer by diffusion, capillary action, phase change to vapor, or other internal transport mechanism and thereby travels from the inner layers to the outer layers towards the free surface. This is in essence the reverse of the process occurring initially when heating from outward-to-inward by thermal convection. Experiments have shown internal heating of the coating can reduce or eliminate the surface defects that often form when heating only from the free surface where the outermost coating layers would solidify and decrease in volume disproportionately relative to successive layers inward and closer to the substrate.

It is also an object of embodiments disclosed herein to mitigate excessive temperature imparted in bare substrate areas by selection and control of the convection air temperature and heat transfer coefficient in relation to the inductive heating intensity applied. The temperature and heat transfer coefficient presented by applied convection air for drying of the wet coating may be selected and controlled to impart a cooling effect to the substrate (e.g., bare foil) which would otherwise be heated to a higher temperature by inductive field coupling alone to counter the tendency for buckling of the substrate due to thermal gradients between coated and uncoated areas.

Further, heating the metal foil substrate from within moderates the thermal expansion strains arising from heating the coated metal composite from the outside coating surface inward. The metal foil substrate is heated concurrently with the wet coating, said foil undergoing thermal expansion growth while the adhered coating layers remain in a liquid or plastic state. Consequently, the strains that would otherwise intensify if the coating were dried and densified prior to the foil growth are now mitigated avoiding the thermal strain defects stated previously. In other words, when the metal foil substrate undergoes thermal expansion growth prior to the solidification of the coating, the coating can fluidly or plastically reshape to conform to the substrate expansion without developing detrimental internal strain energy within the coating layers and/or at the foil-coating interface, thus reducing development of stress fields and thereby avoiding the formation of coating cracking and/or separation (delamination) of the coating from the foil.

Such a method utilizing an internal heating by induction to concurrently heat the metal foil substrate in concert (simultaneously and concurrently in the same position with respect to web travel) with traditional heating methods of convection or convection and IR energy transfer can further enhance the rate of the energy-mass transfer process required to dry the coating. The combining of methods of internal heating with traditional external heating methods may decrease or eliminate the defects that would otherwise necessitate slowing of production speeds or providing longer dryer systems. Therefore, the combining of internal heating and traditional external heating methods such as convection can provide for higher production speeds without the capital outlay for longer dryers. The elimination of coating defects, or the effective minimization of quality defects in the coated electrode foil has the advantage of producing material at a much higher useful yield for electrode production. As there are different grades of electrodes, a product with fewer defects results in a more capable and valuable battery pack.

Accordingly, in certain embodiments disclosed are an apparatus and method for simultaneously drying a coating on a substrate using at least two different drying phenomena, for example, inductive heating and convective heating, or inductive heating and a combination of convective heating and infrared heating. In certain embodiments a coating on a substrate is dried by generating heat in the substrate while simultaneously applying convective heat and/or radiant heat to the coating. Simultaneous drying refers to drying of the same region of a substrate at the same time, and in a particular embodiment, subjecting the same region of a substrate to inductive heating and convection at the same time. Thus, embodiments relate to the synergetic combination of an outside-in/top-down-drying with an inside-out-/bottom-up-heating (e.g., inductive heating). In the case of radiant heat, one suitable approach is to use an infrared float bar, such as the FLOATIR® bar commercially available from Durr Systems, Inc., including the apparatus and method disclosed in U.S. Pat. No. 9,228,779, the disclosure of which is hereby incorporated by reference. In certain embodiments the infrared emitters may be situated as discussed above.

In certain embodiments, disclosed are a method and apparatus to inductively heat a substrate (e.g., a foil web) with a wet coating, wherein the inductive heating is performed concurrently in the same location on said substrate in combination with convection from drying air or gas jets to control the volumetric strain profile within said coating while drying.

In certain embodiments, disclosed are a method and apparatus to apply an induction field to control the thermal expansion of a metal substrate such as a foil relative to one or more coating layers on said substrate while drying.

In certain embodiments, disclosed are a method and apparatus to apply in concurrent time and location on a coated at least partially electrically conductive e substrate a combination of thermal energy by electrical induction and convection to control the drying rate profile of the wet coating as a function of exposure time. The substrate may be coated on one side or on two sides, in which case preferably the two sides are opposing sides.

In certain embodiments, disclosed are a method and apparatus to apply in concurrent time and location on a coated at least partially electrically conductive substrate a combination of thermal energy by electrical induction and convection to control the drying rate profile of the wet coating as a function of percent solids in the coating. The substrate may be coated on one side or on two sides, in which case preferably the two sides are opposing sides.

In certain embodiments, disclosed are a method and apparatus to apply in concurrent time and location on a coated at least partially electrically conductive substrate a combination of thermal energy by electrical induction and convection and infrared heat flux (e.g., such as with a FLOATIR® bar) to control the drying rate profile of a wet coating as a function of exposure time. The substrate may be coated on one side or on two opposing sides.

In certain embodiments, disclosed are a method and apparatus to apply in concurrent time and location on a coated at least partially electrically conductive substrate a combination of thermal energy by electrical induction and convection and infrared heat flux to control the drying rate profile of the wet coating as a function of percent solids in the coating. The substrate may be coated on one side or on two sides, in which case preferably the two sides are opposing sides.

Accordingly, in certain embodiments, disclosed is apparatus for drying a web coating on a region of a travelling web, the web being at least partially electrically conductive, comprising: a dryer enclosure having a web entry opening and a web exit opening spaced from the web entry opening, and at least one drying chamber with at least one nozzle for convectively heating the web, and having at least one inductive heater for inductively heating the web; wherein the at least one nozzle and the at least one inductive heater are positioned in the apparatus to concurrently heat the web coating on the region of the web.

In certain embodiments, the dryer enclosure has a first drying chamber and a second drying chamber downstream, in the direction of web travel, of the first drying chamber. In certain embodiments, the at least one inductive heater is positioned in the first drying chamber, and wherein there is at least one nozzle for convectively heating the web positioned in the first drying chamber and at least one nozzle for convectively heating the web positioned in the second drying chamber.

In certain embodiments, there is at least one inductive heater positioned outside of the dryer enclosure, upstream of the web entry opening.

In certain embodiments, the at least one inductive heater comprises one or more electromagnetic coils located in the dryer enclosure so that convective air jets from the at least one nozzle travel in a space between the one or more electromagnetic coils and a surface of the web such that an oscillating magnetic field penetrating the web and a convective jet field from the at least one nozzle act on the same location of the web at the same time.

In certain embodiments, an inductive heating region in the dryer enclosure extends from the web entry opening to a location in the dryer enclosure where a constant rate period drying ends and a falling rate period of drying begins.

In certain embodiments, the location of the inductive heater and an attendant oscillating power supply are configured to deliver an inductive energy flux absorbed by the web in the range of 1 to 75% of a total drying heat flux in the dryer enclosure. In certain embodiments, the inductive energy flux absorbed by the web is in the range of 10 to 50% of a total drying heat flux in the dryer enclosure.

In certain embodiments, disclosed is a method of drying a conductive substrate being at least partially covered with at least one layer to be dried, comprising heating the substrate by generating heat in the substrate by inductive heating while simultaneously applying convective heat, radiant heat, or both convective heat and radiant heat, to the layer.

In certain embodiments, the substrate is only partially electrically conductive and the heating of the substrate is at least partially carried out with inductive heating.

In certain embodiments, a temperature and heat transfer coefficient presented by applied convection air for drying of the at least one layer is selected and controlled to impart a cooling effect to the substrate which would otherwise be heated to a higher temperature by the inductive heat.

In certain embodiments, the substrate is electrically conductive, and the range of induction heating of the substrate is from 10% to 30% for coat weights of the layer up to 300 grams per square meter.

In certain embodiments, the substrate is electrically conductive, and the range of induction heating of the substrate is from 20% to 40% for coat weights of the layer heavier than 300 grams per square meter.

In certain embodiments disclosed is a method of coating first and second sides of a substrate in a single pass, comprising:
a. applying with a first coater a first coating layer to the first side of the substrate;
b. applying with a second coater a second coating layer to the second side of the substrate;
c. contactlessly drying the first and second coating layers in a flotation dryer positioned downstream of the first and second coaters such that the first and second coating layers retain a predetermined level of a residual moisture when exiting the dryer;
d. inductively heating the substrate in the flotation dryer while simultaneously convectively heating the first and second coating layers; and
e. calendering the coated substrate downstream of said drying.

In certain embodiments, disclosed is a method of applying and drying a coating to a web with a system comprising a supply valve, a bypass valve, a nozzle, a web lifter and a controller to control the supply valve, the bypass valve and the nozzle, the method comprising:
inputting to the controller the reference positions on the web where said supply valve is to open and close;
inputting to the controller the reference positions on the web where the bypass valve is to open and close;
inputting to the controller the reference positions on the web where the web lifter is to be actuated to move the web toward and way from the nozzle;
moving the web past the nozzle;
tracking the position of the web; and
using the controller to control the supply valve, the bypass valve, the nozzle and the web lifter based on the inputted reference positions to deposit the coating on the web;
heating the substrate by generating heat in the substrate by inductive heating while simultaneously applying convective heat, radiant heat, or both convective heat and radiant heat, to the coating.

In certain embodiments, disclosed is a system for applying a coating to a material, travelling in a path, and drying the coating, comprising:
a coater nozzle to apply the coating;
a supply valve in communication with the nozzle to allow the flow of coating to the nozzle;
a bypass valve to direct the flow of coating away from the nozzle;
a fluid displacement mechanism to draw coating away from the nozzle after the supply valve has been closed, wherein the fluid displacement mechanism comprises a chamber having a changeable volume; and
an actuator positioned such that movement of the actuator causes a change in the volume;
a web lifter moveable to deflect the material;
a controller in communication with the supply valve, the bypass valve, the actuator, the nozzle and the web lifter so as to control the application of the coating to the coating; and
a dryer enclosure having a web entry opening and a web exit opening spaced from the web entry opening, and at least one drying chamber with at least one nozzle for convectively heating the web, and having at least one inductive heater for inductively heating the web; wherein the at least one nozzle and the at least one inductive heater are positioned in the apparatus to concurrently heat the web coating on the region of the web.

In certain embodiments, the dryer enclosure of the system has a first drying chamber and a second drying chamber downstream, in the direction of web travel, of the first drying chamber.

In certain embodiments, the at least one inductive heater of the system is positioned in the first drying chamber, and wherein there is at least one nozzle for convectively heating the web positioned in the first drying chamber and at least one nozzle for convectively heating the web positioned in the second drying chamber.

In certain embodiments, there is at least one inductive heater positioned outside of the dryer enclosure of the system, upstream of the web entry opening.

In certain embodiments, the at least one inductive heater of the system comprises one or more electromagnetic coils located in a dryer enclosure having a web entry opening and a web exit opening spaced from the web entry opening, and at least one drying chamber with at least one nozzle for convectively heating the web, and having at least one inductive heater for inductively heating the web; wherein the at least one nozzle and the at least one inductive heater are positioned in the apparatus to concurrently heat the web coating on the region of the web dryer enclosure so that convective air jets from the at least one nozzle travel in a space between the one or more electromagnetic coils and a surface of the web such that an oscillating magnetic field penetrating the web and a convective jet field from the at least one nozzle act on the same location of the web at the same time.

In certain embodiments, an inductive heating region in the dryer enclosure of the system is from the web entry opening to a location in the dryer enclosure where a constant rate period drying ends and a falling rate period of drying begins. In certain embodiments, the location of inductive heater and an attendant oscillating power supply are configured to deliver an inductive energy flux absorbed by the web in the range of 10 to 50% of a total drying heat flux in the dryer enclosure.

### BRIEF DESCRIPTION OF THE DRAWINGS

The embodiments disclosed herein may take form in various components and arrangements of components, and in various process operations and arrangements of process operations. The drawings are for purposes of illustrating preferred embodiments and are not to be construed as limiting.

FIG. 1a is a schematic diagram of a single pass coating layout;

FIG. 1b is a schematic diagram of a double coating layout;

FIG. 2a is a representation of a conductive substrate with bare metal regions providing uncoated foil areas for connection tabs to be connected between individual electrodes in an assembly of battery cells in accordance with certain embodiments;

FIG. 2b is a graph of foil temperature vs. heating time in accordance with the prior art;

FIG. 3a is a top view of apparatus applying transverse electrically conducting, electromagnetic induction coils to a heating moving webs;

FIG. 3b is a schematic view of apparatus applying transverse electrically conducting, electromagnetic induction coils to heating moving webs;

FIG. 4a is a schematic diagram of a single-sided dryer slot nozzle arrangement with electromagnetic coil elements placed between slot nozzles in accordance with certain embodiments;

FIG. 4b is a schematic diagram of a two-sided dryer air bar arrangement with electrically conducting, electromagnetic coils positioned opposite air bar nozzles in accordance with certain embodiments;

FIG. 4c is a schematic diagram of a two-sided dryer air bar arrangement with electrically conducting, electromagnetic coils positioned opposite air bar nozzles and within air bar nozzles in accordance with certain embodiments;

FIG. 4d is a perspective view of a single-sided dryer air foil arrangement with electromagnetic coil elements positioned between air foil nozzles in accordance with certain embodiments;

FIG. 5 is a schematic diagram of the application of induction coils to an otherwise conventional coating line process in accordance with certain embodiments;

FIG. 6a is a graph of foil temperature modeling during convention drying alone in accordance with the prior art;

FIG. 6b is a graph of foil temperature modeling during convention and induction drying;

FIG. 7 is a schematic diagram of the application of inductive field coils to calender temperature control inline process calendering in accordance with certain embodiments;

FIG. 8 is a schematic diagram of the application of inductive field coils to a process that includes secondary dry-down in accordance with certain embodiments;

FIG. 9a is a schematic diagram of the application of inductive coils to a coating line process with inline processing in accordance with certain embodiments;

FIG. 9b is a is a schematic diagram of the application of inductive coils to a coating line process with inline processing and direct post-processing in accordance with certain embodiments;

FIG. 9c is a schematic diagram of the application of inductive coils to a coating line process with secondary lamination in accordance with certain embodiments;

FIG. 10a is a schematic diagram of the application of inductive coils to dry battery electrode (dry powder coating) coating line process that is a single-sided coated process in accordance with certain embodiments;

FIG. 10b is a schematic diagram of the application of inductive coils to dry battery electrode (dry powder coating) coating line process that is a simultaneous double-sided coated process in accordance with certain embodiments;

FIG. 10c is a perspective view of the application of inductive coils to dry battery electrode (dry powder coating) coating line process in accordance with certain embodiments; and

FIGS. 11a and 11b are graphs showing drying profile and volumetric strains in accordance with Example 2.

### DETAILED DESCRIPTION

A more complete understanding of the components, processes, systems and apparatuses disclosed herein can be obtained by reference to the accompanying drawings. The figures are merely schematic representations based on convenience and the ease of demonstrating the present disclosure, and are, therefore, not necessarily intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings. In the drawings and the following description below, it is to be understood that like numeric designations refer to components of like function.

The singular forms “a,” “an,” and “the” include plural referents unless the context clearly dictates otherwise.

As used in the specification, various devices and parts may be described as “comprising” other components. The terms “comprise(s),” “include(s),” “having,” “has,” “can,” “contain(s),” and variants thereof, as used herein, are intended to be open-ended transitional phrases, terms, or words that do not preclude the possibility of additional components.

All ranges disclosed herein are inclusive of the recited endpoint and independently combinable (for example, the range of “from 2 inches to 10 inches” is inclusive of the endpoints, 2 inches and 10 inches, and all the intermediate values).

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.”

It should be noted that many of the terms used herein are relative terms. For example, the terms “upper” and “lower” are relative to each other in location, i.e. an upper component is located at a higher elevation than a lower component, and should not be construed as requiring a particular orientation or location of the structure. As a further example, the terms “interior”, “exterior”, “inward”, and “outward” are relative to a center, and should not be construed as requiring a particular orientation or location of the structure.

The terms “top” and “bottom” are relative to an absolute reference, i.e. the surface of the earth. Put another way, a top location is always located at a higher elevation than a bottom location, toward the surface of the earth.

The terms “horizontal” and “vertical” are used to indicate direction relative to an absolute reference, i.e. ground level. However, these terms should not be construed to require structures to be absolutely parallel or absolutely perpendicular to each other.

The present solution to the problems incurred via the traditional methods of heating and drying thick coatings (e.g., 300-1000 μm) on metal foil substrates is the addition of internal, direct heating of the metal foil independently and preferably simultaneous to external heating methods. Inductive heating provides a suitable and unique means by which the internal, selective heating of the metal foil may be achieved. In Lithium-Ion battery electrode manufacture the metal foil substrates are commonly aluminum and copper in the form of crystal lattice metal ions that are highly electrically conductive. Consequently, the foil structure is subject to reaction to electromagnetic induction via electromagnetic fields, a process known as inductive heating. In certain embodiments, a suitable format of inductive heat application is an induction heater system and the electrically conductive “part” or object or substrate to heat, in a preferred case the metal foil web substrate. The web substrate should be at least partially electrically conductive, and in some embodiments is preferably a metal or graphite foil, a metallized and/or graphite/carbon-added web substrate (e.g., porous, non-woven or woven substrate or foil), or an otherwise conductively prepared, finished or coated web. In some embodiments, the web substrate carries or is at least partially covered with a coating or a coating precursor that becomes a coating upon drying in accordance with embodiments disclosed herein. The coating itself need not be electrically conductive but preferably is. The coating or coating precursor is on at least one major surface of the web substrate, and may be in some embodiments on both major surfaces of the web substrate. In some embodiments, the coating or coating precursor is a slurry for electrodes of Lithium-ion batteries and comprises conductive black carbon, graphite, etc., or may have magnetic properties and comprises nickel, manganese and/or cobalt, in suitable amounts known to those skilled in the art.

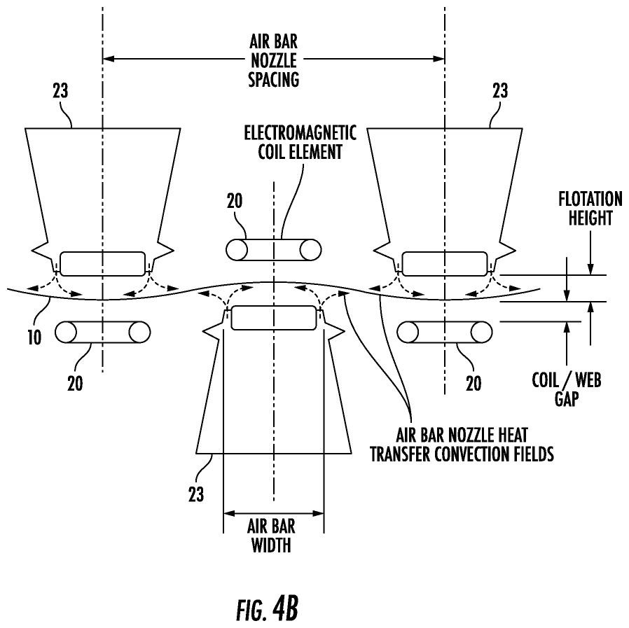

The induction heater may include an electromagnet comprised of a conductive element of appropriate shape, and an electronic oscillator that passes an alternating current (AC) through the electromagnet, as known in the art. The alternating magnetic field penetrates the object, generating electric currents inside the conductive part called eddy currents. The eddy currents flowing through the material of the “part” or object, overcome resistive impedance in the material and heat it by Joule heating. In the case of heating a moving web of material, that being a thickly coated (e.g., 300-10000 μm) metal foil substrate in at least certain regions thereof, the coating may be applied to both sides of the foil, or on one side only. One or more electrically conducting, electromagnetic coils may be placed in close, non-contacting proximity (e.g., between 5-50 mm, preferably 25 mm) near the web on one or both sides, the coil being the source of the alternating magnetic field. The electromagnetic coil element 20, or coil elements, are typically positioned in a plane parallel to the center plane of the web substrate 10 (e.g., in flotation dryers the web is typically floated in a sinusoidal wave, and thus the zero-line of the sinusoidal wave is the center plane in this embodiment) and separated at a distance (e.g., 5-50 mm) avoiding mechanical contact, as depicted in FIGS. 3a and 3b (where like numerals refer to like features of other figures), while the electromagnetic field surrounding each coil element extends into the plane of the web. In the embodiment shown, the web travels from feed roller 16 through the induction field and is taken up by roller 11. The heat then generated within the metal foil substrate tends to increase the foil temperature causing a flux of the heat inside the mass of foil to the coating by means thermal conduction.

In a preferred embodiment the electromagnetic coils are placed inside an oven/dryer enclosure with an oscillating power supply electrically connected to or in electrical communication with said coils. A controller may be used to modulate the power supply. The dryer enclosure is configured with passage openings such as web entry and exit openings or slots, allowing for the traveling web entry path into and web exit path from the enclosure. In some embodiments, the dryer enclosure also includes at least one chamber or zone, and preferably includes a plurality of chambers or zones in fluid communication with one another. For example, the dryer enclosure may have two drying zones, three drying zones, four drying zones, five drying zones, etc., arranged consecutively, in series, in the direction of web travel through the drying enclosure. In some embodiments, the dryer enclosure also includes air or gas supply or circulation, and one or more air or gas nozzles for convectively heating the web substrate as it travels in and through a zone or zones of the dryer enclosure. Thus, within the enclosure, in certain embodiments controlled convection is provided by nozzles or blow boxes 22 discharging air or gas (e.g., air, oxygen-depleted air, nitrogen) in the form of jets supplied by circulating fans conveying the drying air or other gas to promote heat and mass transfer at the surface of the coated web. The air jets from said nozzles 22 may be discharged from one or more continuous slots or from a plurality of apertures such as round holes, rectangles or other shape suited to distribute the air uniformly across the web surface. Drying air may be heated to a controlled temperature by resistance coil heaters, thermal fluid heat exchangers including hot water, steam or thermal oil, or other suitable heating methods known in the field of oven design. Air may be exhausted from the dryer enclosure to ventilate the atmosphere within the dryer keeping moisture and solvent content at controlled levels and preventing exfiltration from the dryer enclosure openings, notably the web entry and exit slots. Further, makeup air may be fed or drawn into the dryer to replace the volume of air (or other gas) exhausted on a continuous basis. Said make-up air may be conditioned to control humidity and/or solvent content, typically by means of controlling the makeup air and exhaust flow rates, and in preferred cases for battery electrode manufacture include drying to low humidity levels to less than negative 40° C. dew point.

In some cases, the web may tolerate mechanical contact with oven internal elements such as rollers.

IR and conductive heating may also use single side flotation using step foils to further optimize the drying process.

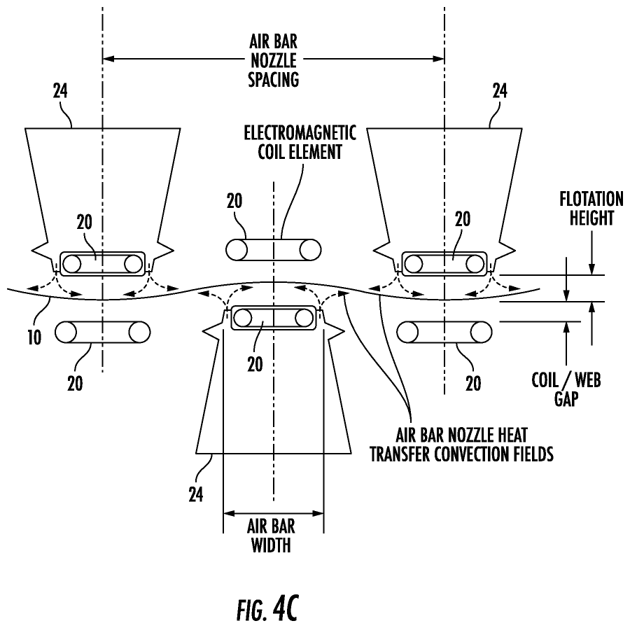

The electromagnetic coil elements 20 may be placed between supply air nozzles 22 as represented in FIG. 4a on one side as shown, with spaced rollers 21 opposing, the coil elements 20 most preferably positioned to generate an oscillating electromagnetic field overlapping and within at least a portion of the convection field created by the air jets discharged from the nozzles 22. It is to be noted that the air jets discharged from the nozzles 22 upon impinging the web 10 surface are redirected by the web surface and follow the surface of the web 10 for some distance from the point or line of impingement, as depicted by the dotted arrows in FIG. 4a. This air flow parallel to the web surface generates desired concurrent convective heat and mass transfer in the air/web boundary layer in the space between the electromagnetic coil element 20 and the web 10.

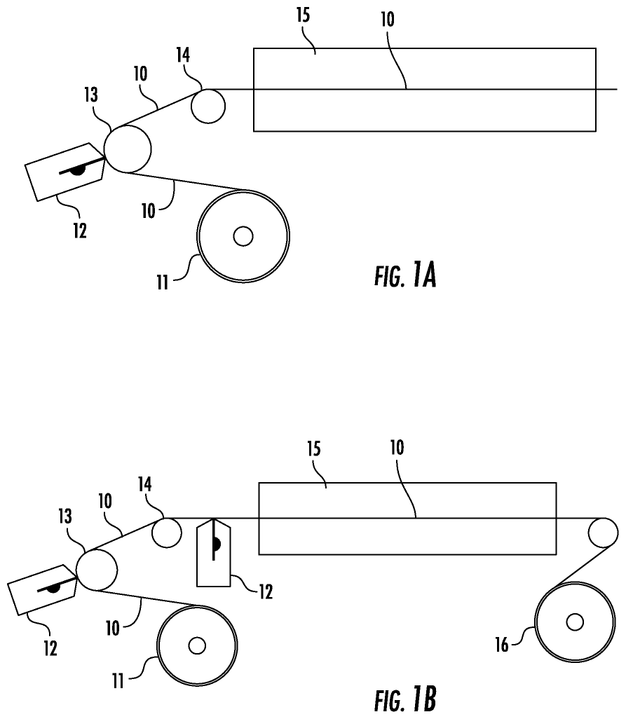

In some cases, the web 10 is coated on both sides as in FIG. 1b, necessitating the avoidance of mechanical contact with the wet coating on either side of the web 10. FIG. 4b shows a preferred embodiment wherein one or more coil elements 20 are placed between flotation air bars 23 which provide convective heat and mass transfer fields in the air/web boundary layer in the space between each electromagnetic coil element 20 and the web 10 and position the web 10 with air cushion support without mechanical contact. The flotation air bars 23 may be of the Coanda type having two slots each forming a nozzle discharging a jet of air creating the heat and mass transfer fields and developing an air cushion between the two said slots for contactless support of the web, such as the HI-FLOAT® air bar commercially available from Durr Systems, Inc., which exhibit high heat transfer and excellent flotation characteristics. Standard 1X HI-FLOAT® air bars are characterized by a spacing between slots of 2.5 inches; a slot width of 0.070 to 0.075 inches, usually 0.0725 inches; an installed pitch of 10 inches; and a web-to-air bar clearance of ⅛ inch. Air bar size can be larger or smaller. For example, air bars ½, 1.5, 2 and 4 times the standard size can be used. In general, the greater distance between the slots results in a larger air pressure pad between the air bar and the web, which allows for increasing the air bar spacing. In a typical dryer configuration with such Coanda flotation nozzles, upper and lower opposing nozzle arrays are provided, with each nozzle in the lower array (except for an end nozzle) positioned between two nozzles in the upper array; i.e., the upper and lower nozzles are staggered with respect to each other. In certain embodiments, one or more nozzles is an elongated member having one or more discharge openings for emitting air or gas, such as an elongated slot, or a plurality of apertures. Each nozzle may include an air or gas-receiving compartment that is in air or gas-receiving communication with a header, which in turn receives air or gas from a suitable source.

In the embodiment of FIG. 4b, the Coanda air bars 23 are positioned on each side of the web 10 and in the direction of web travel and are staggered from each other. The flotation air bars may also be of the air foil or Bernoulli type 24 as shown in FIG. 4d, which contactlessly support the web 10 from one side only, with each air foil bar 24 developing a flotation pressure field between the surface of the air foil bar 25 and the web 10. Said pressure fields exhibit both a positive cushion region and a negative suction region which both pushes the web 10 away from said air foil bar surface 25 and pulls the web 10 toward said surface by negative pressure thus holding the web 10 in a stable position without mechanical contact.

Any number of air bar configurations and positioning may be used. In each case the key feature is that one or more air bars create air convection fields, and one or more electromagnetic coils 20 are located so that the nozzle air jets travel in the space between the electromagnetic coil 20 and the web 10 surface such that the oscillating magnetic field penetrating the web 10 and the convective jet field act on the same location of a moving web 10 at the same time. For example, the air bar arrangement may include air flotation nozzles for floating the web substrate, and direct air impingement nozzles for enhanced drying of the web substrate (and/or coatings thereon). Thus, a plurality of air flotation nozzles or air bars may be mounted in one or more sections of a dryer enclosure in air-receiving communication with headers, preferably both above and below the web substrate for the contactless convection drying of the web substrate. In conjunction with these air flotation nozzles, one or more sections of the dryer may also include direct impingement nozzles such as hole-array bars or slot bars. The drying surface of the web is thus heated by both air issuing from the air flotation nozzles and from the direct impingement nozzles. As a result, the dryer has a high rate of drying in a small, enclosed space while maintaining a comfortable working environment. The nozzle arrangement may include pairs of flotation nozzles directly opposing pairs of direct impingement nozzles.

In some cases, it may be advantageous to construct the supply air nozzles or other internal dryer components of an electrically non-conducting material to avoid the excitation and inductive heat generation within the material of the supply air nozzles or blow boxes themselves due to their proximity to the oscillating magnetic fields from the inductive heating source. In many cases the heat so generated merely contributes to the energy needed to heat the supply air and thus these components are effectively air cooled. In highly compact component arrays local temperatures of the supply air nozzles may cause unacceptable thermal distortion due to expansion of the materials of construction. In such cases the supply air nozzles, air bars, blow boxes etc., may be constructed in whole or in part of non-conducting material such as high-temperature polymers (e.g., polytetrafluoroethylene (TEFLON®), polyphenylene sulfide (PPS), and other polymers that are heat stable above 150° C.), in some cases carbon fiber or glass fiber reinforced as pultrusions, or other composite forms suitable for strength and temperature in dryer oven duty.

An example of a more compact arrangement is shown in FIG. 4c. In this embodiment the electromagnetic coil elements 20 are integrated into the flotation air bar body 24 and act concurrently with the air jet convection fields. In this configuration at least a portion the materials of construction of the air bar body 24 are preferably of electrically non-conductive materials so as to allow development of the electromagnetic field without interference of conductive materials in the air bar body. In certain embodiments, in addition to the electromagnetic coil elements 20 being integrated in the air bar body 24, additional electromagnetic coil elements 20 may be positioned opposite the air bar body 24, i.e., on the opposite side of the web 10, as also shown in FIG. 4c. In certain embodiments, the spacing of the additional electromagnetic coil elements 20 may be chosen to optimize the drying, such as spaced at 10 inch, 15 inch or 20 inch center-to-center.

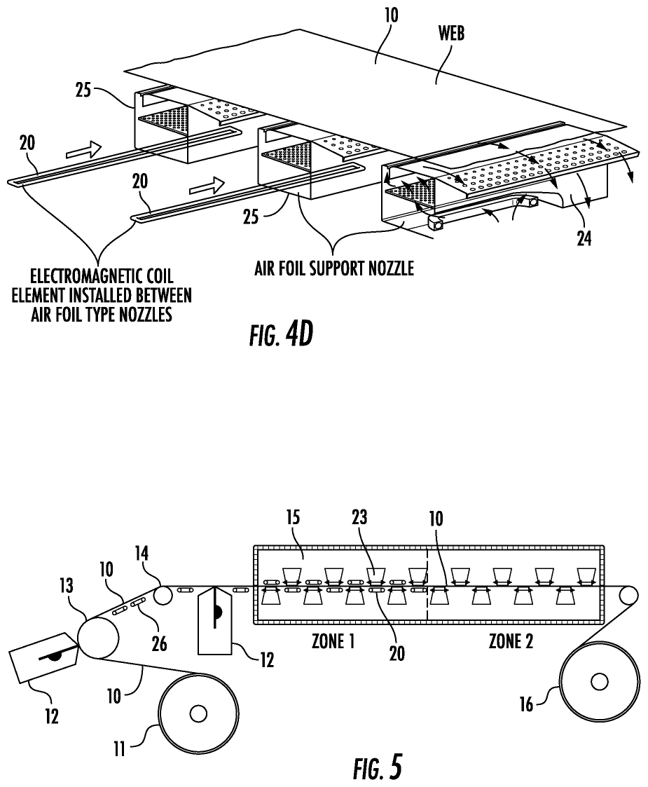

FIG. 5 shows an exemplary embodiment having a plurality of the arrays of the nozzle arrangement of FIG. 4b mounted in a dryer enclosure 15 configured to handle wet coating on both major sides of the web 10. In the embodiment of FIG. 5, a web 10 is conveyed fed via roller 11 to a first slot die coater 12, positioned opposite roller 13, to coat a first major side of web 10, followed by coating with a second free-span slot die coater 12′ downstream of roller 14 to coat a second major side of web 10. The two-side coated web 10 enters dryer 15 through a web entry opening or slot downstream of the slot die coaters. In accordance with certain embodiments, a web lifter or stabilizer (not shown) may be used to move the web relative to slot die coater 12 (and or slot die coater 12′) used in a skip coating or intermittent coating operation, as disclosed in U.S. Pat. No. 9,908,142, the disclosure of which is hereby incorporated by reference. In some embodiments, the web lifter/stabilizer may be actuated to move the web off the die lips of the slot die coater 12 and/or 12′ and stop the application of coating (e.g., slurry) to the web, thereby creating uncoated regions on the web surface. The web lifter/stabilizer device can then be actuated to move the web back into contact with the slot die coater to start the application of coating to the web, thereby creating coated regions on the web surface. In certain embodiments, the web lifting is accomplished by rotating the device in a first direction to lift the web off of the slot die coater and rotating the device back in an opposite direction to return the web back into contact with the slot die coater. A controller can be used to actuate the device. Thus, in certain embodiments, a coater for intermittently applying a coating to a web is provided, and a web lifter and/or stabilizer may be provided upstream of the coater, in the direction opposite of web travel, in a first position. When a gap or skip in coating is desired on the web surface, the web lifter body may be rotated from the first position in a direction toward the web to deflect the web away from the coater (e.g., away from the coater lips) to form a coating gap (e.g., an area or region of web devoid of coating) on the web. The body may be then rotated back to the first position once the desired gap is formed, and negative pressure is maintained during both direction rotations.

In some embodiments, a computer-controlled fluid delivery system may be used to provide precise control of the actuation of valves and movement of the web lifter/stabilizer to create a plurality of coating profiles. Such a system may include a controller, which is used to actuate the valves to begin and terminate the flow of material onto the web through a slot die coater 12 and or 12′. In addition, the controller may displace the web from its on-coat position to an off-coat position away from the web by movement of the web lifter/stabilizer. In some embodiments, a fluid displacement mechanism may be used to temporarily withdraw coating fluid from the slot die lips during the off-coat cycle and return the fluid to the lips during the next on-coat cycle. In two-side coating embodiments, the controller also may be configured to control the start and end locations of the coated patches on the opposite side of the sheet. Registration of the coating can be programmed to be in exact alignment, or advanced or delayed by a specific amount. In addition, the system may be a position based system, thereby being capable of automatically accommodating changes in line speed. Thus, such a coating system for coating a material travelling in a path may include a nozzle to apply the coating; a supply valve in communication with the nozzle to allow the flow of coating to the nozzle; a bypass valve to direct the flow of coating away from the nozzle; a fluid displacement mechanism to draw coating away from the nozzle after the supply valve has been closed, wherein the fluid displacement mechanism may comprise a chamber having a changeable volume; and an actuator positioned such that movement of the actuator causes a change in the volume; a web lifter moveable to deflect the travelling material web; and a controller in communication with the supply valve, the bypass valve, the actuator, the nozzle and the web lifter so as to control the application of the coating to the web of material.

In the embodiment illustrated in FIG. 5, there are two dryer zones, a first zone 1 that includes induction heating coil elements 20, and a second zone 2 downstream of zone 1, in the direction of web travel, devoid of induction heating coil elements. In general, the electromagnetic induction coil elements 20 may be included in a single dryer zone, a portion of a dryer zone, or in a plurality of zones either partially or fully occupying the spaces between convection air bars. In some cases, electromagnetic coil elements 20 may be included throughout the entire dryer length in all zones. The coil elements 20 may be located on one or both sides of the web 10. The web exits dryer 15 via a web exit opening or slot and may be taken up by roller 16, for example.

The selection of the most advantageous drying arrangement from the varied arrangements such as those described above depends at least in part on data and properties of the slurry coating to be applied. These properties include the wet thickness of the coating, the number of sides of the web 10 to be coated (1 or 2), the percent solids of the wet slurry, the type of solvent, the coating line speed and the behavior of the wet coating film during drying as it solidifies. Such design data may be determined from pilot or production trials, laboratory testing and/or computational-based drying models. Determination of optimum drying rate as a function of percent solids or remaining solvent in the coating as it progresses through the applied drying conditions within a drying oven may be obtained by experimental and/or computational methods, preferably both. In the case of induction heating for drying of electrode materials for lithium-ion batteries, a combination of convection drying and induction heating carried out in a concurrent manner is most beneficial as already described.

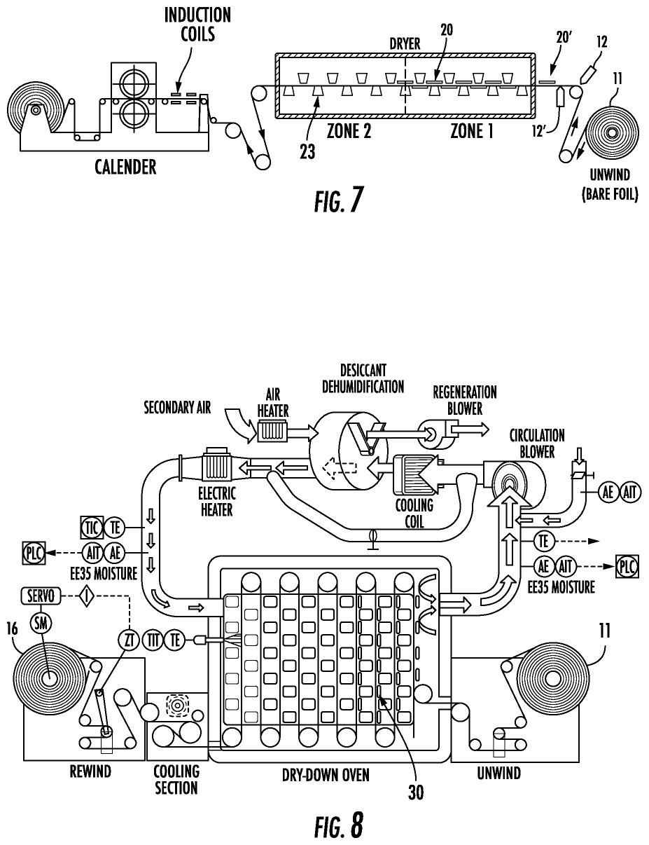

Of design significance is the determination of the portion of the dryer length to be populated with induction coil elements 20. In practice, in the drying of electrode material slurries coated on foil webs, it is often most advantageous to incorporate inductive heating coils early in the drying progress, that is within the first zone or zones of a multi-zone dryer, and in some cases in the path of web travel just prior to the web entering the supply air nozzle convection fields (FIG. 7). In some cases, as exemplified in FIG. 7, where like numerals refer to like features of other figures, one or more electromagnetic coil elements 20′ may be mounted external to the dryer just prior to entering the dryer enclosure (i.e., upstream of the dryer entry). This promotes early heating of the base foil and begins conduction of heat to the wet coating from within with some attendant increase in coating temperature. Optionally, also as shown in FIG. 7, inductive heating coils 20″ may be positioned downstream of the dryer 15, such as in association with a calendering operation, upstream of a calender assembly 200 as shown.

As the web enters the convection fields created by the supply air nozzles, solvent is evaporated driven by convective mass transfer from the surface. In some cases, as the web travels in the dryer, even though heat flux is applied by convection, and may include induction heat, the latent heat of evaporation of solvent causes the temperature of the wet coating to remain steady, as in the analogous case of a wet bulb thermometer. In some cases, the web temperature may decrease slightly or exhibit only a slow increase in temperature as the web continues through the dryer 15. In most cases, the temperature of the wet coating tends toward the wet bulb temperature property of the air supplied to the drying nozzles in the early zones. The wet bulb temperature property may be determined from psychrometric charts or from thermodynamic calculations for water-air or solvent-air mixtures. While the coating surface is relatively wet (often in appearance) the convective drying action will cause a reduction in temperature known as the wet bulb depression. If another source of heating such as induction is imposed in addition to the nozzle supply air convection, the magnitude of the wet bulb depression is reduced. Consequently, the coating will tend to a higher temperature during convective drying with induction added. This is not the case with convection alone, as while the coating surface is of sufficient moisture (or solvent concentration), the magnitude of the wet bulb depression remains constant regardless of the magnitude of the convection. While in this stage of drying, often referred to as the “constant rate period” of drying, the surface of an electrode slurry coating appears wet and/or darker in color as the solvent (water or organic solvent) is plentiful at the surface. As the web 10 moves through the dryer 15 and drying progresses, solvent continues to be evaporated, and at some point the coating surface begins to take on a dry and/or lighter color appearance owing to the reduction of liquid solvent at the surface. Beyond this drying time and location as the web progresses further, the temperature of the coating surface begins to increase more rapidly, indicating the drying rate is now falling. The surface is now partially or substantially solidified while the coating underneath the surface yet contains significant solvent. It is at this critical time and location in the dryer that defects such as mud cracks tend to begin to form if the drying rate is too aggressive, that is driven too quickly by the magnitude of convection field created by the drying air velocity and temperature preceding that point. It is up to this distance location in web travel (or equivalent residence time by distance and web speed) along the dryer length from the web entry where the addition of inductive heating coil elements between convection air nozzles is most preferred. That is, the inductive heating region is preferably from the entry of the dryer to the location where constant rate period drying ends and the falling rate period of drying begins. If there are to be a number of electrode coatings products to be processed in a given coating line dryer, one would identify this distance according to wet coat weight thickness, desired line speed and coating sensitivity to form such defects for each product, and then select the longest value result from the set of all such products. It may also be preferable to extend the addition of inductive heating coil filaments to this length by, for example, 25% and perhaps up to 50% more in length to accommodate new electrode manufacturing specifications and slurry compositions in consideration of future needs. Thus, the inductive heating elements may be extended 25%, 30%, 35%, 40%, 45%, or 50% beyond the inductive heating region in the dryer, or any percentage amount between these values.

FIG. 8 illustrates the application of inductive field coils to a process that includes secondary dry-down. In the embodiment shown, induction coils are provided in a dry-down oven. Air vented from the oven may be circulated to a desiccant dehumidification system and sent back to the dry-down oven as shown. The path of the web is it is unwound coated, heated, dried, cooled, and rewound. When the web is in the dryer, the induction coils will begin to heat the metal web. The temperature of the web will increase until the slurry reaches a steady state evaporation. As the web is drying and passes between air bars, the web temperature will drop due to increased evaporation of the solvent. After the induction heaters, the product will stay in the oven for some time. The product will go through its final drying in this portion, very minimal solvents remaining. Dry air will be supplied to the drier. The solvent laden air will leave the dryer and go into the desiccant unit. The air will then be heated back up and supplied back to the dryer.

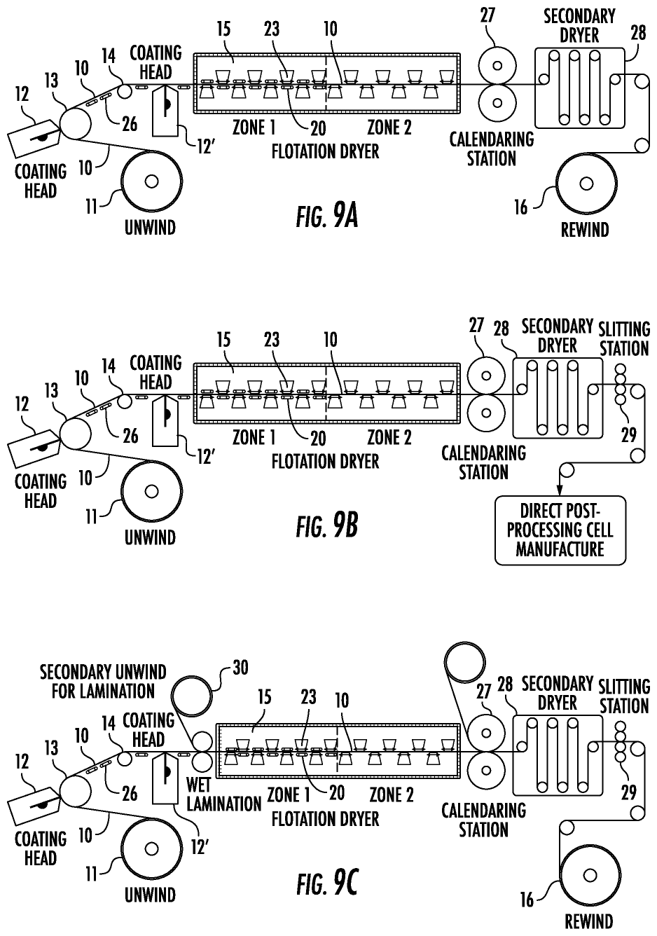

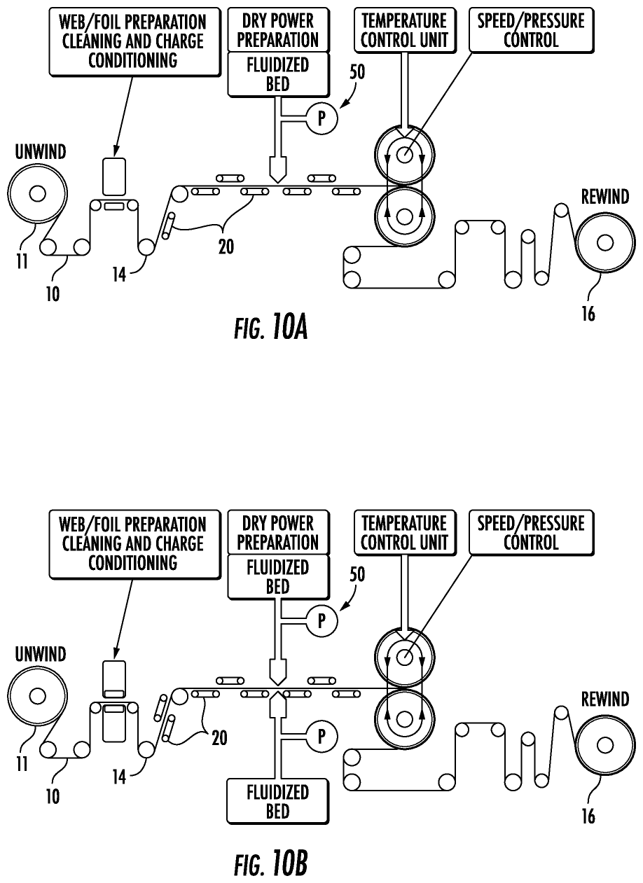

FIG. 9a illustrates the use of induction heating elements 20 in a coating line process with inline processing. In this embodiment, the dryer 15 includes inductive heating elements 20 in only zone 1 of a two zone dryer, with Coanda air bar nozzles 23 positioned in both zone 1 and zone 2 of dryer 15 as shown. Coating heads 12 and 12′ apply coatings to respective sides of web 10 upstream of the dryer 15. The web 10 exits the dryer 15 and travels to calendering station 27, followed by further drying in a secondary dryer 28, after which the web 10 is wound on roller 16. Induction heating elements 26 may be positioned upstream of the dryer as shown.

FIG. 9b illustrates a similar embodiment to FIG. 9a, except that downstream of the secondary dryer 28, the web 10 is sent to a slitting station 29 followed by direct post-processing operations.

FIG. 9c illustrates an embodiment similar to FIG. 9a, with a secondary lamination operation, and a slitting station 29 after secondary drying.

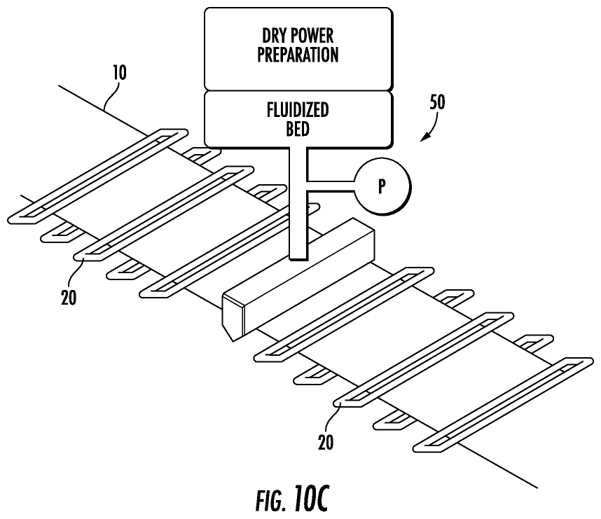

FIGS. 10a, 10b and 10c illustrate a dry powder coating embodiment where a dryer enclosure is not used. Induction heating elements 20 are positioned both upstream and downstream of a fluidized bed dry powder application station 50, preferably on opposite sides of the web 10 in a staggered fashion.

In as much as the addition of concurrent induction heating to convection heating provides improvement in the reduction of volumetric strain in the coating layers, at the same time an excessive application of induction heating will cause thermal strain and buckling in the foil between coated and uncoated areas, thereby a preferred range for the portion of induction heating is desired. Laboratory experiments and numerical simulations indicate the preferred contribution of heating capacity to the web from the added induction heating coil elements and respective oscillating power supplies is typically in the range of 10 to 50% of the total drying energy flux in the constant rate drying zones. That is, in certain embodiments, the induction heating coil elements to be installed in the above-described portion of the dryer length (the inductive heating region) and attendant oscillating power supply is selected to deliver an inductive energy flux absorbed by the foil web in the range of 10 to 50% of total drying heat flux. A controller may be used to control the power supply.

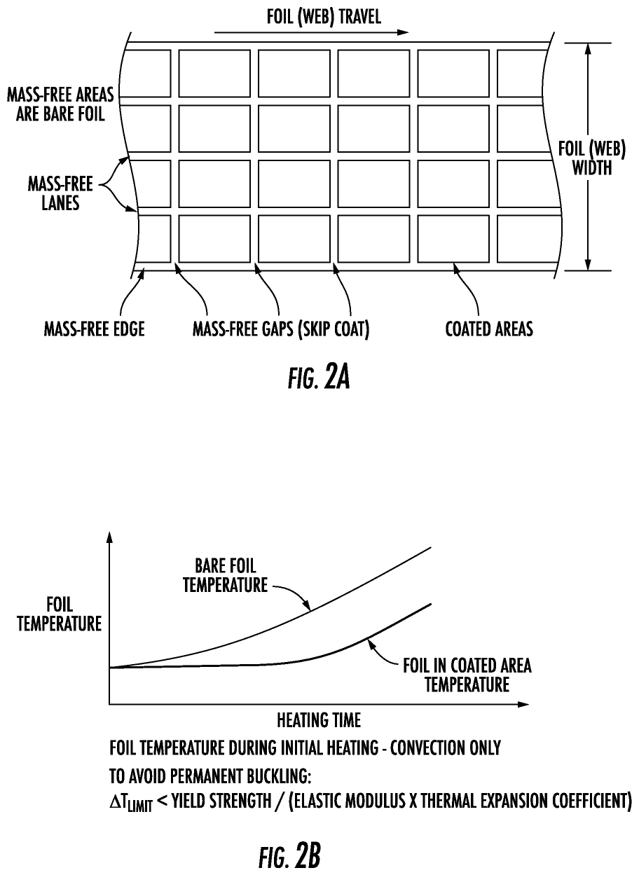

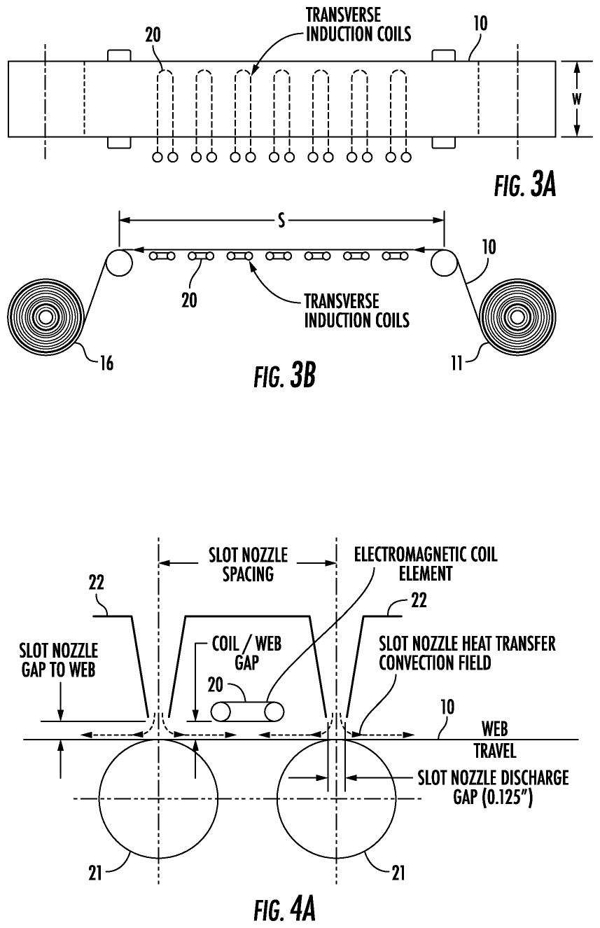

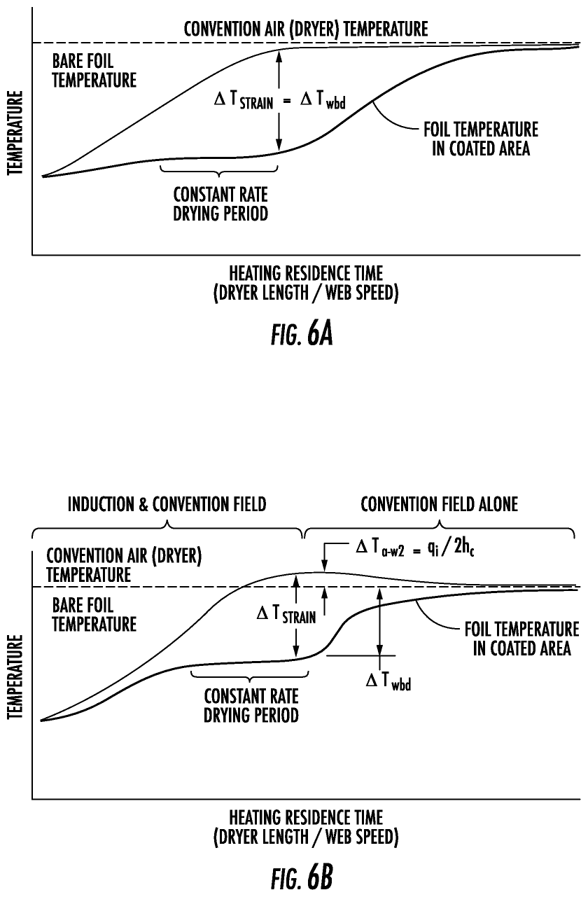

Determination of the practical limit of induction heat flux may be based on estimating the thermal strain between coated and uncoated areas of the web as noted in FIG. 2b. This calculation is based on the material properties of the coated base foil and the design drying rate calculations for convection alone as practiced in current art. FIG. 6a represents such a drying process as practiced in convection dyers of current art. FIG. 6b represents drying with the addition of concurrent induction heating of the base foil in accordance with certain embodiments. In the convection-only case of FIG. 6a, the magnitude of thermal strain may be determined by assuming the bare foil closely approaches the temperature of the convection air supplied to the air nozzle jets, while in that same location along the direction of web travel within the oven the wet coating and the foil in contact with the coating at that location approach the wet bulb temperature property of the supply air and the properties of the solvent in the wet electrode coating (slurry). The difference in these two temperature values is known as the wet bulb depression (wbd) in psychrometric calculations in the fields of engineering and meteorology. This wet bulb depression value is expressed as a difference in temperatures and is therefore properly given units of temperature degrees as opposed to degrees. For example, the wet bulb depression figure should be expressed in Centigrade degrees (C. degrees) or Fahrenheit degrees (F. degrees), not ° C. or ° F. Conversions of these temperature difference values must be made accordingly.

The described wet bulb depression value represents at least a relative magnitude of the thermal strain created between a coated area of foil and an uncoated area of foil along the line created by the coating edge or edges as represented in FIG. 2a. The design limit of the thermal strain can be estimated as follows:

$$Δ {T}_{s t r a i n} < \frac{{f}_{D} \times Yield Strength for Buckling}{Elastic Modulus \times Thermal Expansion Coefficient}$$

where f_{D} is a deflection force.
If this temperature difference, as estimated from the wet bulb depression, is reduced, the relative thermal strain in the foil is proportionately reduced. For instance, if the wet bulb depression with induction heat flux added were reduced to half of the value considering convection only, the resulting thermal stress is essentially reduced by half.

In the case of convection only, the wet bulb depression as known in the field of psychrometry is often expressed as:

$$Δ {T}_{w b d} = {T}_{a} - {T}_{w} = \frac{{H}_{vap} ( {Y}_{w} - {Y}_{a} )}{( {h}_{c} / {k}_{x} )}$$

where:
Tₐ is the temperature of the supplied drying air to the nozzle jets
T_{w} is the local web temperature≈psychrometric wet bulb temperature of the supplied air in constant rate drying.
Hᵥₐₚ is the heat of vaporization of the solvent
Y_{w} is the humidity of the solvent at T_{w} determined from psychrometric charts or thermodynamic equations of state
Yₐ is the humidity of the drying air supplied to the nozzle jets.
(h_{c}/kₓ) is the ratio of heat transfer coefficient to mass transfer coefficient, typically determined by the Chilton-Colburn equation in engineering mass transfer texts from known solvent properties.
   According to the referenced Chilton-Colburn analogy, any increase or decrease in the magnitude of the convective heat transfer coefficient will bring about a proportional and corresponding increase or decrease in the magnitude of the mass transfer coefficient. Thereby the magnitude of the wet bulb depression temperature difference remains essentially constant even if the convection heat transfer field in contact with the web is changed by supplying increased or decreased air pressure to the nozzle jets to create higher or lower impingement velocity, or by increasing or decreasing the size of the nozzle jets mass to alter the flow quantity of supply air delivered by the nozzle jets.

In contrast to the case of heating by convection alone, the wet bulb depression may be altered by adding a non-convective heat flux source. Induction heating provides such a thermal mechanism. In a simple but useful approach to estimating the effect, the contribution of induction heat may be expressed as a factor representing an amount of heat flux to displace a fraction of the base case heat flux with convection only, thereby modifying the above equation as follows:

$$Reduced Δ {T}_{w b d} = {T}_{a} - {T}_{w} = \frac{( 1 - {f}_{i} ) {H}_{v a p} ( {Y}_{w} - {Y}_{a} )}{( {h}_{c} / {k}_{x} )}$$

where:
fᵢ is the proportional factor of induction flux displacing the base case convective flux
   For instance, if induction heat is applied at ⅓ the magnitude of the base convective heat flux for the convection-only case, fᵢ=0.33 and magnitude of the wet bulb depression is reduced by a factor of 0.67. Comparison of FIG. 6b to FIG. 6a depicts such a reduction in the wet bulb depression magnitude, translating to reduced thermal strain, ΔTₛₜᵣₐᵢₙ.

Various of the operations described herein may include a controller or control system. For any such control system, a suitable controller may be used, such as a controller having a processing unit and a storage element. The processing unit may be a general-purpose computing device such as a microprocessor. Alternatively, it may be a specialized processing device, such as a programmable logic controller (PLC) or a proportional-integral-derivative controller (PID). The storage element may utilize any memory technology, such as RAM, DRAM, ROM, Flash ROM, EEROM, NVRAM, magnetic media, or any other medium suitable to hold computer readable data and instructions. The controller unit may be in electrical communication (e.g., wired, wirelessly) with one or more of the operating units in the system, including one or more valves, actuators, sensors, conveyers, etc. The controller also may be associated with a human machine interface or HMI that displays or otherwise indicates to an operator one or more of the parameters involved in operating the system and/or carrying out the methods described herein. The storage element may contain instructions, which when executed by the processing unit, enable the system to perform the functions described herein. In some embodiments, more than one controller may be used.

### EXAMPLE 1

The drying energy flux by convection alone in a constant rate zone as determined from test data, basic drying calculations (such as the wet bulb method above) or computational modeling with a 2-sided air bar nozzle array having a heat transfer coefficient of 85 watts/m²-Cdegree per side with a supply air at 80° C. and an average zone web temperature of 65° C. The base convection flux from the design target drying rate can be calculated as:

$${q}_{convection} = 2 {h}_{c} ( {T}_{a} - {T}_{w} )$$

$${q}_{convection} = 2 sides \times 85 watts / {m}^{2} - Cdegree \times ( 80 ° C . - 65 ° C . ) = 2500 watts / {m}^{2}$$

Note the implied wet bulb depression ΔT_{wbd}=Tₐ−T_{w}=15 C degrees in the convection-only base case.

In this example, choosing a target of 33% for the inductive flux to displace a portion of the convective heat results in fi=0.33. The wet bulb depression is modified to give:

$$Δ {T}_{w b d} = ( 1 - 0.33 ) \times 15 C . degrees = 10 C . degrees$$

As depicted in FIG. 6b the bare foil temperature tends to increase to a temperature exceeding the convection air temperature owing to the addition of induction heat flux. In this condition, the convection air acts to cool the bare foil by countering the heating by inductive flux. A balance point and maximum bare foil temperature is reached and the when the inductive flux is equal to the cooling heat flux of the concurrent convection field wherein for a two-sided convection nozzle array:

$$Δ {T}_{a - w 2} = {q}_{i} / 2 {h}_{c} = {f}_{i} {q}_{convection} / 2 {h}_{c}$$

where nomenclature is as recited above and:
ΔT_{a-w2} is the temperature difference between the supplied drying air to the nozzle jets and the bare foil web temperature at the end of the concurrent induction plus convection fields.
qᵢ is the effective inductive heat flux electromagnetically coupled with the metal foil generating heat in the foil.
h_{c} is the convective heat transfer coefficient imparted on the web by the nozzle jets over the convective field created by the air motion of the jets, per side of the web
   In this example,

$$Δ {T}_{a - w 2} = 0.33 \times 2550 watts / {m}^{2} / ( 2 \times 85 watts / {m}^{2} - Cdegree ) = 5 C . degrees$$

The combined thermal strain is the sum of the reduced ΔT_{wbd} and ΔT_{a-w2} as depicted in FIG. 6b.

$$Δ {T}_{s t r a i n} = 10 C . degrees + 5 C . degrees = 15 C . degrees$$

For this example, a copper foil having a yield strength for buckling of 69 MPa, an elastic modulus of 117,000 MPa, a coefficient of thermal expansion of 17×10⁻³ mm/mm per C degree and applying a design factor f_{D} of 0.7 result in a design limit of:

$$Δ {T}_{strain limit} = 0.7 \times 69 MPa / ( 117 MPa \times 17 \times {10}^{- 3} mm / mm - Cdegree ) = 24 C . degrees$$

The design induction flux at 33% of the base convection case results in an estimated thermal strain which is less than the above limit strain, hence the design is acceptable. If the estimated thermal strain had exceeded the limit, a lower design level for the inductive flux would be selected and re-evaluated as above until a satisfactory result is obtained.

In operation, the delivered flux is preferably controlled and modulated to deliver in the range of 10 to 33% of said convection flux, that is 255 to 842 watts/m² electromagnetically coupled to and heating the base foil. In some cases the design selection of the inductive heating elements and oscillating power source may be selected to deliver a greater inductive flux in excess of the foregoing calculated value to provide reserve capacity according to desired drying rate and dried coating quality considerations.

The foregoing example provides a simplified method for design sizing of inductive heating components. Alternate methods may be applied including numerical finite element methods, analytical mathematics, lab or pilot test work, or other suitable development tools known to those skilled in the art. Calculation of the drying profile in terms of percent solvent and corresponding volume fraction of solvent in the wet coating may be determined by finite element computation. Shrinkage and volume reduction of the wet slurry coating thorough the drying progression may be quantified. Comparing drying cases with concurrent induction heating plus convection drying may be compared to cases with convection only. Application of induction heating can reveal a favorable reduction in the volume stress developed within the coating as a function of time or position in the dryer (drying profile).

### EXAMPLE 2

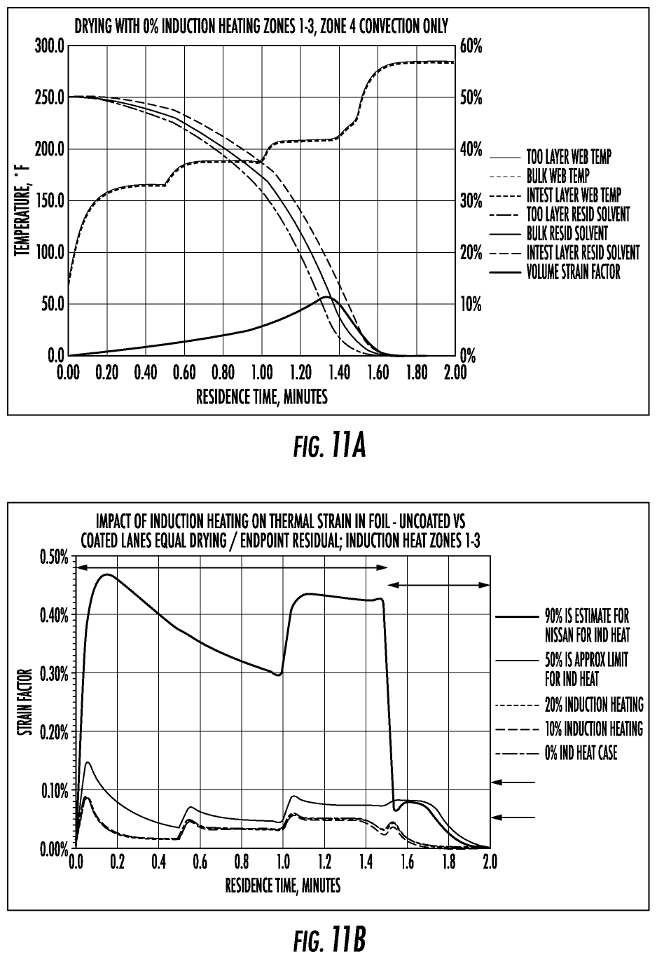

Example description here showing graph of drying profile and volumetric strains per FIG. 11a, where each web temperature has a given steady state evaporation rate. The induction heating can get the web to higher temperatures then convection heating alone. As the product is drying the strain on the product increases as the layers of residual solvent are different within the product. FIG. 11b is a graph showing thermal strains in foil as it goes through the dryer. It shows the different strains induced on the web at different induction fluxes.

The following table summarizes the result of numerical finite element modeling of an anode battery slurry coating with convection only compared to several cases with increasing proportion of induction heating added concurrently to the convection.

Numerical Calculation of Maximum Coating Volumetric
Strain 200 gsm Dry Coat Weight Anode Coating

| | Calculated | Calculated Thermal |
|---|---|---|
| Design Target | Maximum | Strain in Foil |
| Induction Heat | Volumetric Strain | (limit = 0.04%) |
| 0% | 11.3% | 0.04% |
| 10% | 5.4% | 0.04% |
| 20% | 1.2% | 0.04% |
| 50% | 1.0% | 0.10% |
| 90% | <1% | 0.34% |

As can be seen in the table, most of the favorable benefit in reduction of coating volumetric strain during drying and solidification is realized with a minor portion of the drying heat flux from induction flux. In fact, the range of 10% to 20% provides considerable improvement over the case of convection alone (0%). Increasing the portion of induction flux up to 90% results in only minor if any useful impact on the volume strain. On the other hand, a large contribution of drying heat flux, on the order of 50% or more from induction, results in large thermal strain in the foil between coated and uncoated areas. Accordingly, the preferred range of induction heating of anode electrode materials is from 10% to 30% for typical dry coat weights up to 300 grams per square meter. In the case of heavier dry coat weights, similar analysis as in the above table shows the preferred range is from 20% to 40% of heat flux from induction. Cathode coatings on aluminum foil substrate exhibit similar results for volumetric strain behavior, however the thermal strain limit for aluminum foil is on the order of 2 times greater that of copper allowing cathode materials to be dried with up to 50% induction heat contribution. For an oven system to be configured to handle drying of a number of different electrode formulations and dry coat weights the induction heating coil elements and oscillating power supply (supplies) are preferable selected and installed to provide inductive field capacity to deliver electromagnetically coupled to heat the foil in the range of 10% to 50% of the total drying heat flux. This represents a delivered heat flux in the preferred range of 200 to 1500 watts/m² for design sizing of installed capacity with convection heat transfer fields in the range of 25 to 125 watts/m² per degree per side for lithium-ion battery electrode materials of present makeup. These ranges may be expanded to cover other materials in accordance with the invention respecting preferred limits of volume strain in the coating and thermal strain limits respective of conductive base web materials to be processed and dried.

Induction heating may be used to raise the temperature of the coated and substantially dried web after calendering (to minimize the size and cost of a secondary dryer and/or maximize throughput line speed) and concurrent convection may be applied to limit temperature strains between coated and uncoated areas. Similarly, inductive flux ranges and strain limits may be determined when heating a coated foil that is substantially dry, as in secondary drying applications following calendering operations on coated electrodes, such as this part of the drying/heating curve (depicted with the arrow):

While various aspects and embodiments have been disclosed herein, other aspects, embodiments, modifications and alterations will be apparent to those skilled in the art upon reading and understanding the preceding detailed description. The various aspects and embodiments disclosed herein are for purposes of illustration and are not intended to be limiting. It is intended that the present disclosure be construed as including all such aspects, embodiments, modifications and alterations insofar as they come within the scope of the appended claims or the equivalents thereof.

What is claimed is:

1. Apparatus for drying a web coating on a region of a travelling web, the web being at least partially electrically conductive, comprising:
a dryer enclosure having a web entry opening and a web exit opening spaced from said web entry opening, and at least one drying chamber with at least one nozzle for convectively heating said web, and having at least one inductive heater for inductively heating said web;
wherein said at least one nozzle and said at least one inductive heater are positioned in said apparatus to concurrently heat said web coating on said region of said web.

2. The apparatus of claim 1, wherein said dryer enclosure has a first drying chamber and a second drying chamber downstream, in the direction of web travel, of said first drying chamber.

3. The apparatus of claim 2, wherein said at least one inductive heater is positioned in said first drying chamber, and wherein there is at least one nozzle for convectively heating said web positioned in said first drying chamber and at least one nozzle for convectively heating said web positioned in said second drying chamber.

4. The apparatus of claim 1, further comprising at least one inductive heater positioned outside of said dryer enclosure, upstream of said web entry opening.

5. The apparatus of claim 1, wherein said at least one inductive heater comprises one or more electromagnetic coils located in said dryer enclosure so that convective air jets from said at least one nozzle travel in a space between said one or more electromagnetic coils and a surface of said web such that an oscillating magnetic field penetrating the web and a convective jet field from said at least one nozzle act on the same location of said web at the same time.

6. The apparatus of claim 1, wherein an inductive heating region in said dryer enclosure extends from the web entry opening to a location in said dryer enclosure where a constant rate period drying ends and a falling rate period of drying begins.

7. The apparatus of claim 1, wherein the location of said inductive heater and an attendant oscillating power supply are configured to deliver an inductive energy flux absorbed by said web in the range of 1 to 75% of a total drying heat flux in said dryer enclosure.

8. The apparatus of claim 7, wherein the inductive energy flux absorbed by said web is in the range of 10 to 50% of a total drying heat flux in said dryer enclosure.

9. A method of drying a conductive substrate being at least partially covered with at least one layer to be dried, comprising heating the substrate by generating heat in the substrate by inductive heating while simultaneously applying convective heat, radiant heat, or both convective heat and radiant heat, to the layer.

10. The method of claim 9, wherein the substrate is only partially electrically conductive and the heating of the substrate is at least partially carried out with inductive heating.

11. The method of claim 9, wherein a temperature and heat transfer coefficient presented by applied convection air for drying of the at least one layer is selected and controlled to impart a cooling effect to the substrate which would otherwise be heated to a higher temperature by said inductive heat.

12. The method of claim 9, wherein said substrate is electrically conductive, and wherein the range of induction heating of said substrate is from 10% to 30% for coat weights of said layer up to 300 grams per square meter.

13. The method of claim 9, wherein said substrate is electrically conductive, and wherein the range of induction heating of said substrate is from 20% to 40% for coat weights of said layer heavier than 300 grams per square meter.

14. A method of coating first and second sides of a substrate in a single pass, comprising:
a. applying with a first coater a first coating layer to the first side of said substrate;
b. applying with a second coater a second coating layer to the second side of said substrate;
c. contactlessly drying said first and second coating layers in a flotation dryer positioned downstream of said first and second coaters such that the first and second coating layers retain a predetermined level of a residual moisture when exiting said dryer;
d. inductively heating said substrate in said flotation dryer while simultaneously convectively heating said first and second coating layers; and
e. calendering said coated substrate downstream of said drying.

15. A method of applying and drying a coating to a web with a system comprising a supply valve, a bypass valve, a nozzle, a web lifter and a controller to control said supply valve, said bypass valve and said nozzle, said method comprising:
inputting to said controller the reference positions on said web where said supply valve is to open and close;
inputting to said controller the reference positions on said web where said bypass valve is to open and close;
inputting to said controller the reference positions on said web where said web lifter is to be actuated to move said web toward and way from said nozzle;
moving said web past said nozzle;
tracking the position of said web; and
using said controller to control said supply valve, said bypass valve, said nozzle and said web lifter based on said inputted reference positions to deposit said coating on said web; and
heating said substrate by generating heat in the substrate by inductive heating while simultaneously applying convective heat, radiant heat, or both convective heat and radiant heat, to the coating.

16. A system for applying a coating to a material, travelling in a path, and drying said coating, comprising:
a coater nozzle to apply said coating;
a supply valve in communication with said nozzle to allow the flow of coating to said nozzle;
a bypass valve to direct the flow of coating away from said nozzle;
a fluid displacement mechanism to draw coating away from said nozzle after said supply valve has been closed, wherein said fluid displacement mechanism comprises a chamber having a changeable volume; and
an actuator positioned such that movement of said actuator causes a change in said volume;
a web lifter moveable to deflect said material;
a controller in communication with said supply valve, said bypass valve, said actuator, said nozzle and said web lifter so as to control the application of said coating to said coating; and
the apparatus of claim 1.

17. The system of claim 16, wherein said dryer enclosure has a first drying chamber and a second drying chamber downstream, in the direction of web travel, of said first drying chamber.

18. The system of claim 17, wherein said at least one inductive heater is positioned in said first drying chamber, and wherein there is at least one nozzle for convectively heating said web positioned in said first drying chamber and at least one nozzle for convectively heating said web positioned in said second drying chamber.

19. The system of claim 16, further comprising at least one inductive heater positioned outside of said dryer enclosure, upstream of said web entry opening.

20. The system of claim 16, wherein said at least one inductive heater comprises one or more electromagnetic coils located in said dryer enclosure so that convective air jets from said at least one nozzle travel in a space between said one or more electromagnetic coils and a surface of said web such that an oscillating magnetic field penetrating the web and a convective jet field from said at least one nozzle act on the same location of said web at the same time.

21. The system of claim 16, wherein an inductive heating region in said dryer enclosure is from the web entry opening to a location in said dryer enclosure where a constant rate period drying ends and a falling rate period of drying begins.

22. The system of claim 16, wherein the location of said inductive heater and an attendant oscillating power supply are configured to deliver an inductive energy flux absorbed by said web in the range of 10 to 50% of a total drying heat flux in said dryer enclosure.
